(19) United States
(12) Patent Application Publication
(10) Pub. No.: US 2019/0227691 A1
(43) Pub. Date: Jul. 25, 2019

(54) CONTROLLING A TOUCH-SENSITIVE DISPLAY UNIT

(71) Applicant: HEWLETT-PACKARD DEVELOPMENT COMPANY, L.P., HOUSTON, TX (US)

(72) Inventors: HSIN-HUI HUANG, TAIPEI CITY (TW); SHAN-CHIH CHEN, TAIPEI CITY (TW)

(21) Appl. No.: 16/323,081

(22) PCT Filed: Oct. 11, 2016
(86) PCT No.: PCT/US2016/056331

§ 371 Date: Feb. 4, 2019

(51) Int. Cl. G06F 3/041; G06F 3/0488; G02F 1/1333

(52) U.S. Cl. CPC G06F 3/04166; G02F 1/13338; G06F 3/0488

(57) ABSTRACT

Controlling a touch-sensitive display unit is described. In an example implementation, a physical configuration of a mobile computing device is identified. The physical configuration may be one of a clamshell mode and a tablet mode. Further, based on the physical configuration of the mobile computing device, the operational state of the touch-sensitive display unit of the mobile computing device is switched to one of an active state and an inactive state.

### BACKGROUND

Over the years, computing devices have evolved from desktop computers to tablets and other mobile devices. The evolution in the computing devices is not restricted to the form factor of the computing devices but is also seen through various functionalities provided to users. For example, laptops or tablets, amongst other things, offer mobility to the users in comparison to desktop computers. In addition, convertible laptops have provided flexibility to the users to use the computing devices as laptops or tablets as per their convenience.

### BRIEF DESCRIPTION OF DRAWINGS

The following detailed description references the drawings, wherein:

FIG. 1 illustrates a block diagram of a mobile computing device, according to an example implementation of the present subject matter.

FIG. 2 illustrates another block diagram of a mobile computing device, according to an example implementation of the present subject matter.

FIG. 3 illustrates a method for controlling a touch-sensitive display unit of a mobile computing device, according to an example implementation of the present subject matter.

FIG. 4 illustrates a method for controlling a touch-sensitive display unit of a mobile computing device, according to another example implementation of the present subject matter,

FIG. 5 illustrates a computer readable medium storing instructions for controlling a touch-sensitive display unit of a mobile computing device, according to an example implementation of the present subject matter.

### DETAILED DESCRIPTION

Convertible computing devices, such as convertible laptops provide ease of usage due to their capability of being used as a laptop as well as a tablet. Generally, a convertible computing device may be used in a clamshell mode or a tablet mode. In the tablet mode, the display unit of the convertible computing device may be detached from a keyboard of the convertible computing device for being used as an independent computing device. In certain tablets, the display unit is not detachable: instead is foldable backwards to function as a tablet.

Mostly, in the clamshell mode, the keyboard and the display unit are connected together by a hinge, such that the display unit forms a right angle with the keyboard. However, there may be certain computing devices, where the display unit though connected with the keyboard, a display panel of the display unit is not facing the keyboard. In such computing devices, the display unit acts as a tablet. In order to achieve the above-mentioned configurations, i.e., convertibility of laptops, the display unit of the convertible computing device is generally touch-sensitive so as to receive tactile input.

When the convertible computing device is used in the clamshell mode, users tend to use an input device, such as a keyboard, for entering input, instead of using the touch-sensitive capability of the display unit. In such a case, the display unit may go in an idle mode. However, the touch sensors of the display unit continue to scan the display unit for any user input even in the idle mode. This may cause consumption of a significant amount of power by the display unit, even in the idle mode. In certain cases, the display unit may go into a selective suspend mode, in which the consumption of power by the display unit is same as the idle mode. However, while switching from the selective suspend mode to a normal operational state, the display unit becomes slow in operation. The consumption of power by the display unit in the idle mode may degrade a battery life of the mobile computing device. Moreover, the switching time taken by the display unit in the selective suspend mode may be inconvenient to users.

Approaches for reducing consumption of power by a touch-sensitive display unit (hereinafter referred to as the display unit) of a mobile computing device are described herein. The present subject matter includes identifying a physical configuration of the mobile computing device. In an example, the physical configuration is one of a tablet mode and a clamshell mode. Based on the physical configuration, an operational state of the display unit of the mobile computing device is switched between one of an active state and an inactive state.

In an example implementation, the mobile computing system is a convertible computing system that may either be used in the clamshell mode or the tablet mode. In the clamshell mode, the input unit may be connected to the display unit at a certain angle. In addition, a display panel of the display unit is facing towards the input unit. For example, the input unit may be connected to the display unit by means of a hinge. In the tablet mode, the display unit may be either detached from the input unit or may be swiveled and folded backwards to touch the input unit or the display panel may not be facing towards the input unit.

The mobile computing system further includes a control engine for identifying the physical configuration of the mobile computing system. The physical configuration of the mobile computing device is identified based on a connection between the input unit and the display unit, In an example, if the input unit is not connected to the display unit, the physical configuration is considered as the tablet mode. In another example, if the input unit is connected to the display unit, the physical configuration may be identified based on a coupling angle between the display unit and the input device or the direction of the display panel.

In case the coupling angle of the mobile computing system is greater than a ore-defined angle, the physical configuration of the mobile computing device is considered to be the tablet mode. On the other hand, when the coupling angle is less than the pre-defined angle, the physical configuration of the mobile computing device is considered to be the clamshell mode. Based on the coupling angle, the control engine may switch an operational state of the display unit. In an example implementation, the operational state may be switched between an active state and an inactive state. In an example implementation, the control engine may communicate with at least one accelerometer sensor located around the hinge to ascertain the coupling angle.

The switching of the operational state of the display unit enables in saving power consumed by the display unit when the mobile computing device is in the clamshell mode. The present subject matter also provides flexibility to the user while reducing the power consumption.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject natter, as well as specific examples thereof, are intended to encompass equivalents thereof.

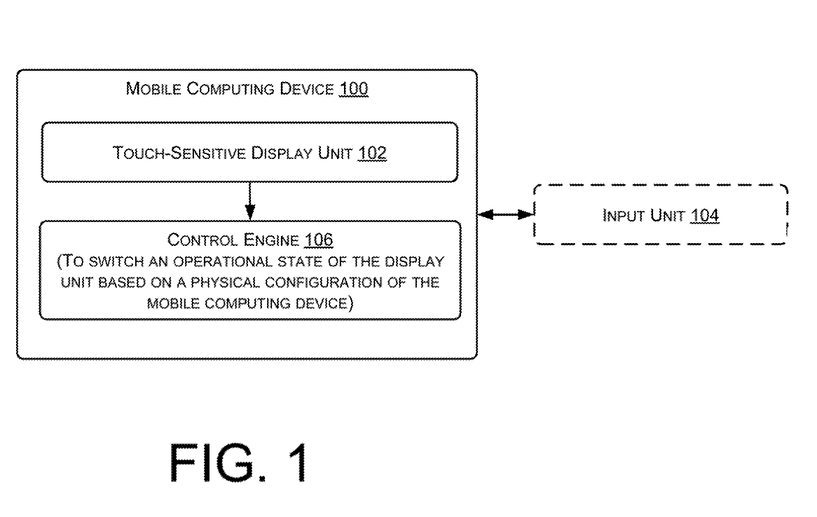

FIG. 1 illustrates a block diagram of a mobile computing device 100, for controlling a touch-sensitive display unit 102, according to an example implementation of the present subject matter. In one example, the mobile computing device 100 may be a hybrid computing device, such as a convertible laptop or a detachable laptop. While the capability of controlling the touch-sensitive display unit 102 (hereinafter referred to as the display unit 102) is shown implemented in the mobile computing device 100, such capability can be provided separately for being implemented in any hybrid computing device.

In an implementation, the mobile computing device 100 may be connected to an input unit 104. The input unit 104 may be any device that may be connected to the mobile computing device 100 and is used for providing input. For example, where the mobile computing device 100 is used as a tablet, the input unit 104 may be a soft keyboard that may be connected to the tablet. In cases, where the mobile computing device 100 is used as a laptop, the input unit 104 may be a standard keyboard. It may be noted that input unit 104 is considered as a keyboard, it may be any other device that may facilitate in providing input. In an example, the display unit 102 may be connected to the input unit 104 by a coupling mechanism, The coupling mechanism facilitates in movement of the display unit 102 along a horizontal axis (not shown).

Further, the mobile computing device 100 includes a control engine 106. In an example implementation, the control engine 106 may switch an operational state of the display unit 102 between an active state and an inactive state. The operational state may be indicative of a responsiveness of a tactile input by the display unit 102. In case where the display unit 102 responds to a touch input, the operational state of the display unit 102 is considered to be the active state. On the other hand, where the display unit 102 does not respond to the touch input, the operational state of the display unit 102 is considered to be the inactive state.

In order to switch the operational state of the display unit 102, the control engine 106 determines a physical configuration of the mobile computing device 100. The physical configuration may be understood as a physical layout of the mobile computing system, In an example, the physical configuration may be defined based on a connection between the display unit 102 and the input unit 104. For instance, when the display unit 102 is not connected to the input unit 104, the physical configuration of the mobile computing device 100 is considered as a tablet mode.

The physical configuration may also be considered as the tablet mode when the display unit 102 is removed and re-attached with the input unit 104 in such a manner that a display panel of the display unit 102 faces away from the input unit 104. Further, the mobile computing device 100 may be considered to be in the table mode when the display unit 102 is folded back such that the input unit 104 is facing downwards, to provide an easel-like stand.

In another example, the physical configuration may be defined on the basis of a coupling angle defined between the display unit 102 and the input unit 104. For instance, if the coupling angle is less than a pre-defined angle, the physical configuration of the mobile computing device 100 is considered to be a clamshell mode or a notebook mode or a standard laptop mode.

When the physical configuration of the mobile computing device 100 is identified as the clamshell mode, the control engine 106 may send a command to the display unit 102 to switch the operational state to the inactive state. As mentioned above, in the inactive state, the display unit 102 stops detecting any touch input provided by a user. The control engine 106 thereby facilitates in reducing the power consumed by the display unit 102, especially in the clamshell mode, where the input is mostly provided using the input unit 104. In addition, the present subject matter enables in saving power of a battery of the mobile computing device 100.

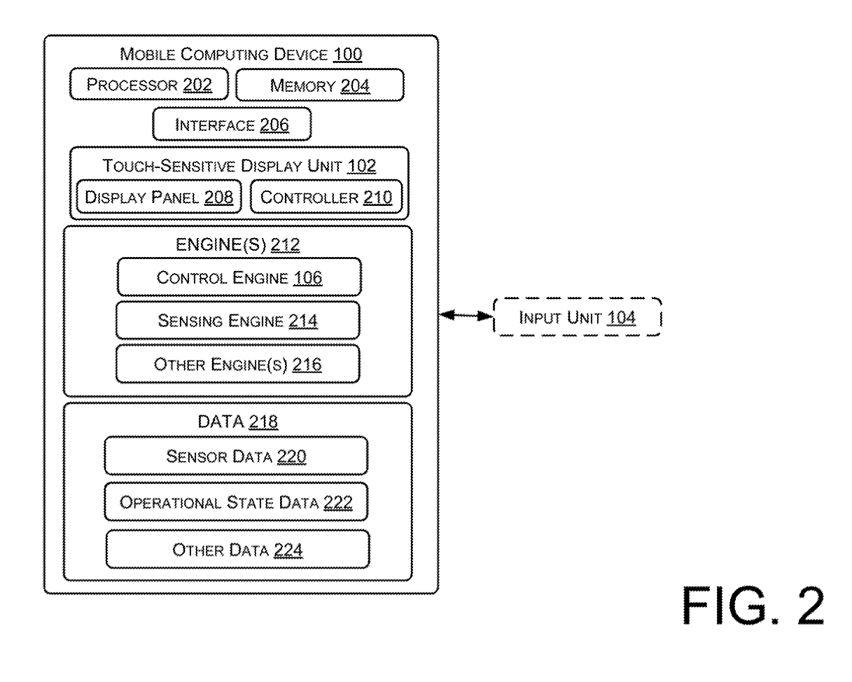

The above aspects and further details are described in conjunction with FIG. 2. FIG. 2 illustrates another block diagram of the mobile computing device 100 for controlling a touch-sensitive display device 102, according to an example implementation of the present subject matter. As mentioned previously, the mobile computing device 100 may be implemented as hybrid computing systems, such as a convertible laptop or a detachable laptop.

In one implementation, the mobile computing device 100 includes a processor 202 and a memory 204 coupled to the processor 202. The processor 202 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labeled as “processor(s)”, may be provided through the use of dedicated hardware as well as hardware capable of executing computer-readable instructions.

The memory 204, communicatively coupled to the processor 202, can include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The mobile computing device 100 also includes interface(s) 206. The interfaces 206 may include a variety of interfaces, for example, interfaces 206 for users, The interface(s) 206 may include data output devices. The interface(s) 206 facilitate the communication of the mobile computing device 100 with various communication and computing devices and various communication networks, such as networks that use a variety of protocols, for example, Hypertext Transfer Protocol (HTTP) and Transmission Control Protocol/Internet Protocol (TCP/IP).

Further, the mobile computing device 100 may include the display unit 102 that may be connected to the input device 104. As described above, the display unit 102 is a touch-sensitive display unit. Examples of the input unit 104 may include, but are not limited to, a keyboard, a joystick, and a mouse. In an example implementation, the display unit 102 is attached to the input device 104 by a coupling mechanism, such as a hinge. The display unit 102 may be switched between an active state and an inactive state.

In an example implementation, the display unit 102 may include a display panel 208 and a controller 210 for detecting any tactile input from a user. The display panel 208 may be employed for presenting visual content. The display panel 208 may include, but is not limited to, a liquid crystal display (LCD), a light emitting diode (LED) display, and an organic LED (OLED) display. Examples of the visual content may include, but are not limited to, still images, videos, text, and graphics.

The controller 210 may receive commands from different sub-units of the mobile computing device 100. Based on the physical configuration of the mobile computing device 100, the controller 210 may receive instructions to switch the operational state of the display unit 102 between the active state and the inactive state. In an example, in the active state, the controller 210 may start detecting the tactile input and in the inactive state, the controller 210 may stop detecting the tactile input.

For example, in order to switch an operational state of the display unit 102, the control engine 106 may send a command to the controller 210 to detect or not to detect the tactile input. In an example, the controller 210 may be a touch Integrated Circuit (IC) embedded in the display unit 102. In another example, the control engine 106 may send the command to the controller 210 through a Universal Serial (USB) Bus or an Inter Integrated Circuit (I2C) bus.

In yet another example, the control engine 106 may send the command to the controller 210 through a Serial Peripheral Interface (SPI) bus. Though the present subject matter describes communication between the control engine 106 and the controller 210 through the USB bus or I2C bus or SPI bus, the control engine 106 may communicate with the controller 210 by any other suitable communication protocol.

The mobile computing device 100 may further include engines 212. The engines 212, amongst other things, include routines, programs, objects, components, and data structures, which perform particular tasks or implement particular abstract data types. The engines 212 may also be implemented as, signal processor(s), state machine(s), logic circuitries, and/or any other device or component that manipulates signals based on operational instructions. Further, the engines 212 can be implemented by hardware, by computer-readable instructions executed by a processing unit, or by a combination thereof. In one implementation, the engines 212 include the control engine 106, a sensing engine 212, and other engine(s) 216. The other engine(s) 216 may include programs or coded instructions that supplement the applications or functions performed by the mobile computing device 100, The engines 212 may be implemented as described in relation to FIGS. 1 and 2.

In an example, the mobile computing device 100 includes data 218. The data 218 may include sensor data 220, operational state data 222, and other data 224. The other data 224 may include data generated and saved by the engines 212 for implementing various functionalities of the mobile computing device 100.

In an example, the control engine 106 may ascertain whether a power saving mode has been turned ON by the user or not. The power saving mode will facilitate a user to reduce consumption of power by the display unit 102, in the clamshell mode. If the power saving mode is not turned ON by the user, the display unit 102 may receive touch input from the users.

Consider the scenario where the user has turned ON the power saving mode. In this scenario, the control engine 106 may identify the physical configuration of the mobile computing device 100. In an example implementation, the control engine 106 instructs a Basic Input/Output System (BIOS) to determine the physical configuration of the mobile computing device 100. The BIOS, while booting the mobile computing device 100, scans the mobile computing device 100 to identify the physical configuration of the mobile computing device 100. In an example, the BIOS communicates with the sensing engine 214 to determine the physical configuration of the mobile computing device 100.

In an example implementation, the sensing engine 214 may communicate with accelerometer sensors that may be placed near the hinge and the keyboard to retrieve information pertaining to the physical configuration of the mobile computing device 100. The accelerometer sensors may detect attachment or detachment of the display unit 102 with the input unit 104. The accelerometer sensors may also identify whether the display panel 208 of the display unit 102 is facing towards the input unit 104 or away from the input unit 104. In another example, the accelerometer sensors may also identify a coupling angle that may be defined between the display unit 102 and the input unit 104. Based on the coupling angle, the accelerometer sensors may determine whether the display unit 102 is folded back or not.

Accordingly, the accelerometer sensors may be disposed near the hinge and the keyboard to sense any uncoupling of the display unit 102 or change in the coupling angle between the display unit 102 and the input unit 104. In an implementation, information pertaining to the coupling and the coupling angle may be stored as the sensor data 220.

The sensing engine 214 may share the sensor data 220 with the control engine 106. Based on the sensor data 220, the control engine 106 may identify the physical configuration of the mobile computing device 100. For example, when the sensor data 220 indicates that the display unit 102 is not connected with the input unit 104, the control engine 106 may identify the physical configuration of the mobile computing device 100 as the tablet mode. In case of detachable laptops, when a touch screen, such as the display unit 102, is detached from a keyboard, such as the input unit 104, the physical configuration may be considered as the tablet mode.

In another example, when the sensor data 220 indicates that the display unit 102 is connected to the input unit 104, the control engine 106 may determine the coupling angle defined between the display unit 102 and the input unit 104. If the coupling angle is less than a pre-defined angle, such as 120 degrees, the control engine 106 may identify the physical configuration as the clamshell mode. In case of convertible laptops, the touch screen is not detached from the keyboard, instead is folded backwards. Therefore, based on the coupling angle defined between the display unit 102 and the input unit 104, the control engine 106 may identify the physical configuration as the clamshell mode or the tablet mode.

Once the physical configuration of the mobile computing device 100 is identified, the control engine 106 sends a request to the controller 210 to provide information about a current operational state of the display unit 102. In an example, the controller 210 may access the operational state data 222 to retrieve information pertaining to the current operational state of the mobile communication device 100. Based on the current operational state, the control engine 106 may direct the controller 210 to either switch the operational state or to remain in the current operational state.

For example, if the mobile computing device 100 is in the clamshell mode and the user has not turned ON the power saving mode, the controller 210 maintains the display unit 102 in active state and continues to detect any touch input. When the display unit 102 is detached from the input unit 104, as the display unit 102 is already in the active state, the control engine 106 may instruct the controller 210 to maintain the active state of the display unit 102. On the other hand, if the power saving mode is turned ON and the physical configuration of the mobile computing device 100 is identified as the clamshell mode, the display unit 102 goes into the inactive state. The present subject matter, thus saves power of a battery of the mobile computing device 100. When the physical configuration of the mobile computing device 100 changes, i.e., to the tablet mode, the control engine 106 may send a command to the controller 210 to switch the operational state of the display unit 102 into the active state.

Based on the change in the operational state of the display unit 102, the present subject matter seeks to manage the power consumed in different physical configurations of the mobile computing device 100. The present subject matter facilitates in reducing power consumption by the display unit 102 in the clamshell mode.

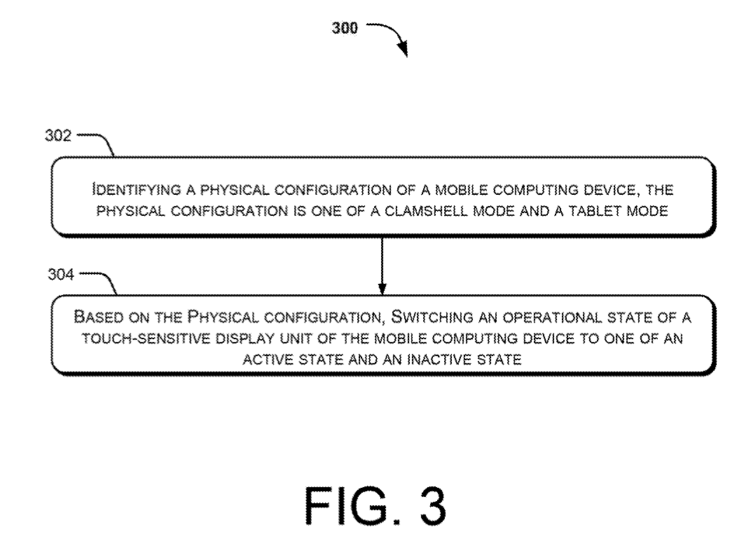

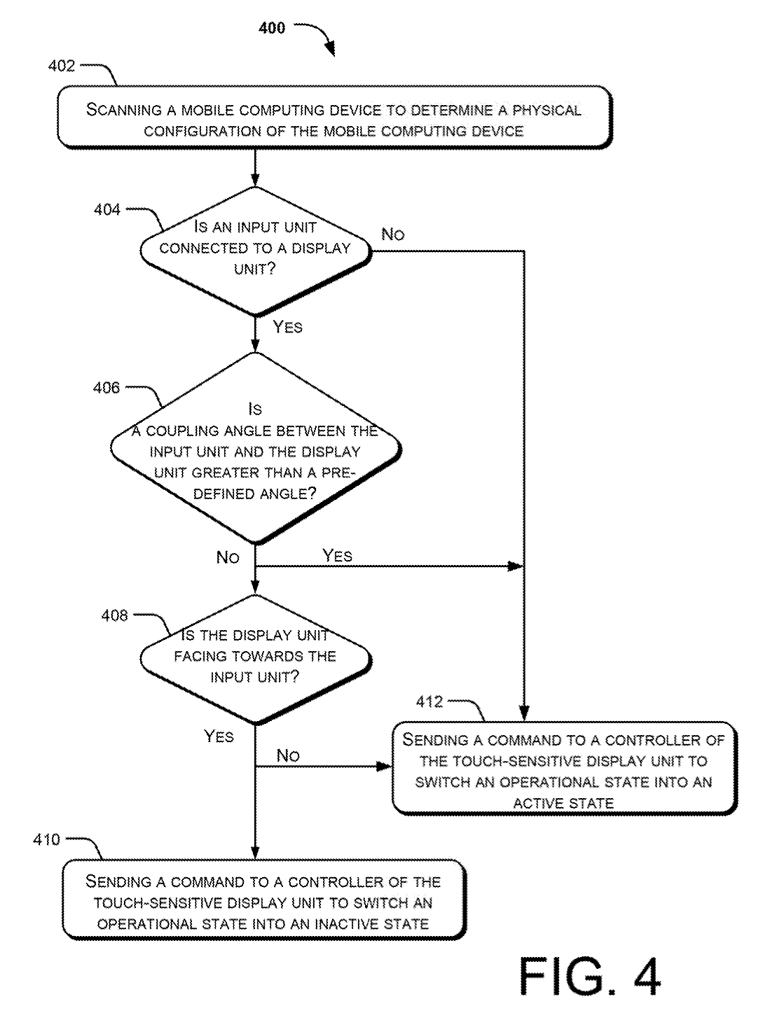

FIGS. 3 and 4 illustrate methods 300 and 400 for controlling a touch-sensitive display unit 102, according to example implementations of the present subject matter. The order in which the methods 300 and 400 are described is not intended to be construed as a limitation, and some of the described method blocks can be combined in a different order to implement the methods 300 and 400, or an alternative method. Additionally, individual blocks may be deleted from the method 400 without departing from the subject matter described herein. Furthermore, the methods 300 and 400 may be implemented in any suitable hardware, computer-readable instructions, or combination thereof.

The methods 300 and 400 may be performed by either a computing device under the instruction of machine executable instructions stored on a computer readable medium or by dedicated hardware circuits, microcontrollers, or logic circuits. Herein, some examples are also intended to cover computer readable medium, for example, digital data storage media, which are machine or computer readable and encode machine-executable or computer-executable instructions, where said instructions perform some or all of the steps of the described methods 300 and 400.

With reference to method 300 as depicted in FIG. 3, at block 302, a physical configuration of a mobile computing device 100 is identified. The physical configuration may be one of a clamshell mode or a tablet mode. In an example implementation, the control engine 106 identifies the physical configuration through a Basic Input/Output System (BIOS) of the mobile computing device 100. The BIOS, while booting the mobile computing device 100, may identify the physical configuration of the mobile computing device 100.

Further, at block 304, based on the physical configuration of the mobile computing device 100, an operational state of the touch-sensitive display unit 102 may be switched between an active state and an inactive state. In an example implementation, the control engine 106 may send a command to the controller 210 of the display unit 102 to switch the operational state of the display unit 102 in accordance with the physical configuration of the mobile computing device 100. For example, when the mobile computing device 100 is in the tablet mode, the control engine 106 may send the command to the controller 210 to switch the operational state of the display unit 102 to the active state.

Reference is now made to method 400 illustrated in FIG. 4. The method 400 depicts a scenario, where the power saving mode is turned ON by the user. At block 402, the mobile computing device 100 is scanned to determine a physical configuration of the mobile computing device 100. In an example implementation, the control engine 106 may instruct the BIOS to scan the mobile computing device 100 in order to identify the physical configuration.

At block 404, it is determined whether the input unit 104 and the display unit 102 are connected to each other. In an example implementation, the sensing engine 214 communicates with the accelerometer sensors to determine the connection between the display unit 102 and the input unit 104. In an example, if the display unit 102 is detached from the input unit 104, the mobile computing device 100 is considered to be in the tablet mode and the method moves to block 412. In another example, if the display unit 102 is attached to the input unit 104, the mobile computing device 100 is considered to be in the clamshell mode and the method moves to block 406.

At block 406, it is determined if the coupling angle between the input unit 104 and the display unit 102 is greater than a pre-defined angle. In an example implementation, the sensing engine 214 identifies the coupling angle between the display unit 102 and the input unit 104. In an example, if the coupling angle is greater than the pre-defined angle, the mobile computing device 100 is considered to be in the tablet mode and the method moves to block 412. The pre-defined angle may be 200 degrees. In another example, if the coupling angle is less than the pre-defined angle, the mobile computing device 100 is considered to be in the clamshell mode and the method moves to block 408.

At block 408, it is determined if the display unit 102 is facing towards the input unit 104. In an example implementation, the sensing engine 214 identifies the direction of the display unit 102 with respect to the input unit 104. In an example, if the display unit 102 is facing away from the input unit 104, the mobile computing device 100 is considered to be in the tablet mode and the method moves to block 412. In another example, if display unit 102 is facing towards the input unit 104, the mobile computing device 100 is considered to be in the clamshell mode and the method moves to block 410.

At block 410, a command is sent to a controller 210 of the display unit 102 to switch an operational state of the display unit 102 into the inactive state. In an example implementation, the control engine 106 sends the command to the controller 210. In the inactive state, the display unit 102 does not detect any touch input provided by the user, thus saving power of a battery of the mobile computing device 100.

Further, at block 412, a command is sent to a controller 210 of the display unit 102 to switch an operational state of the display unit 102 into the active state. In an example implementation, the control engine 106 sends the command to the controller 210, In the active state, the display unit 102 starts detecting any touch input provided by the user.

In an example, the controller 210 may be a touch Integrated Circuit (IC) embedded in the display unit 102. In another example, the control engine 106 may send the command to the controller 210 through a Universal Serial (USB) Bus or an Inter Integrated Circuit (I2C) bus. In yet another example, the control engine 106 may send the command to the controller 210 through a Serial Peripheral Interface (SPI) bus. Though the present subject matter describes communication between the control engine 106 and the controller 210 through the USB bus or I2C bus or SPI bus, the control engine 106 may communicate with the controller 210 by any other suitable communication protocol.

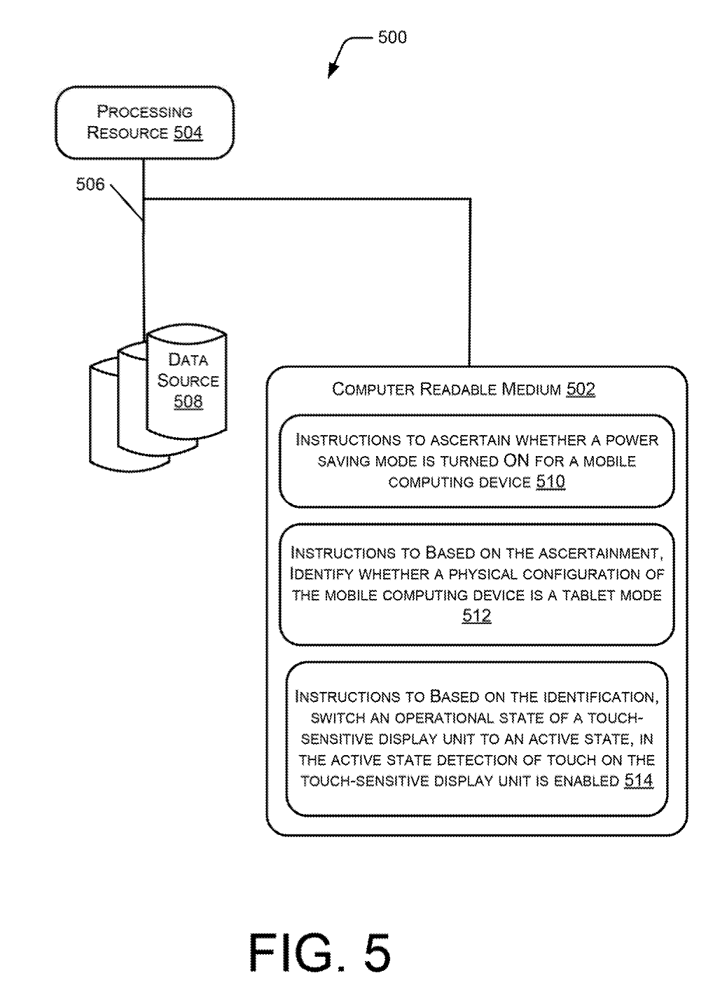

FIG. 5 illustrates an example system environment 500 using a non-transitory computer readable medium 502 for controlling a touch-sensitive display unit 102, according to an example implementation of the present subject matter. The system environment 500 includes a processing resource 504 communicatively coupled to the non-transitory computer readable medium 502 through a communication link 506. In an example, the processing resource 504 can be a processor of a mobile computing device, such as the mobile computing device 100 for fetching and executing computer-readable instructions from the non-transitory computer-readable medium 502.

The non-transitory computer readable medium 502 can be, for example, an internal memory device or an external memory device. In one implementation, the communication link 506 may be a direct communication link, such as one formed through a memory read/write interface. In another implementation the communication link 506 may be an indirect communication link, such as one formed through a network interface. In such a case, the processing resource 504 can access the non-transitory computer readable medium 502 through a communication network (not shown).

The processing resource 504 and the non-transitory computer readable medium 502 may also be communicatively coupled to data source 508. The data source 508 can include, for example, a sensing engine. In an example implementation, the non-transitory computer readable medium 502 includes a set of computer readable instructions for controlling the display unit 102. The set of computer readable instructions, referred to as instructions hereinafter, can be accessed by the processing resource 504 through the communication link 506 and subsequently executed to perform acts for controlling the display unit 102.

Referring to FIG. 5, in an example, the non-transitory computer-readable medium 502 my include instructions 510 to ascertain whether a power saving mode is turned ON for a mobile computing device 100. The non-transitory computer-readable medium 502 may include instructions 512 to, identify whether a physical configuration of the mobile computing device 100 is a tablet mode, based on the ascertainment. In an example implementation, the identification is done by the control engine 106. The control engine 106 receives sensor data 220 from the sensing engine 212.

In an example, the sensor data 220 indicates whether the display unit 102 is connected to the input unit 104. If not, the mobile computing device 100 is considered to be in the tablet mode. In another example, if the display unit 102 is connected to the input unit 104, the sensor data 220 may also indicate whether a coupling angle defined between the display unit 102 and the input unit 104 is greater than a pre-defined angle. Further, the sensor data 220 indicates whether the display panel 208 the display unit 102 is facing away from the input unit 104. If so, the mobile computing device 100 is considered to be in the tablet mode.

The non-transitory computer-readable medium 502 may include instructions 514 to, switch an operational state of the display unit 104 to an active state, based on the identification. In the active state, detection of a touch on the display unit 102 is enabled. In an example implementation, the control engine 106 may, based on the physical configuration, send a command to a controller 210 of the display unit 102 to enable detection of a touch input.

Although examples for the present disclosure have been described in language specific to structural features and/or methods, it is to be understood that the appended claims are not limited to the specific features or methods described herein. Rather, the specific features and methods are disclosed and explained as examples of the present disclosure.

I/We claim:

1. A mobile computing device to be connected to are input e mobile computing device comprising:
a touch-sensitive display unit; and
a control engine to.
identify whether a physical configuration of the mobile computing device is a clamshell mode; and
based on the identification, switch an operational state of the touch-sensitive display unit to an inactive state, wherein in the inactive state detection of a touch on the touch-sensitive display unit is disabled.

2. The mobile computing device as claimed in claim 1, wherein the control engine is to determine whether a power saving mode is turned ON for the mobile computing device.

3. The mobile computing device as claimed in claim 1, wherein the control engine is to identify the physical configuration based on connection between the input unit and the touch-sensitive display unit.

4. The mobile computing device as claimed in claim 3, wherein the control engine is to identify the physical configuration based on a direction of a display panel with respect to the input unit.

5. The mobile computing device as claimed in claim 1, wherein the control engine is to identify the physical configuration based on a coupling angle defined between the input unit and the touch-sensitive display unit.

6. The mobile computing device as claimed in claim 1, wherein the control engine is to send a command to a controller of the touch-sensitive display unit to switch the operational state to the inactive state.

7. A method comprising:
identifying a physical configuration of a mobile computing device, wherein the physical configuration is one of a clamshell mode and a tablet mode; and
based on the physical configuration of the mobile computing device, switching an operational state of a touch-sensitive display unit of the mobile computing device to one of an active state and an inactive state.

8. The method as claimed in claim 7, wherein the identifying comprises scanning the mobile computing device to determine connection between an input device with the touch-sensitive display unit.

9. The method as claimed in claim 8, wherein based on the scanning, determining a coupling angle defined between the input unit and the touch-sensitive display unit.

10. The method as claimed in claim 7, wherein the identifying comprises determining a direction of a display panel of the touch-sensitive display unit with respect to an input unit.

11. The method as claimed in claim 7, wherein the switching comprises sending a command to a controller of the touch-sensitive display unit to switch the operational state.

12. Anon-transitory computer-readable medium having a set of computer readable instructions that, when executed, cause a control engine to,
ascertain whether a power saving ode is turned ON for a mobile computing device;
based on the ascertainment, identify whether a physical configuration of the mobile computing device is a tablet mode: and
based on the identification, switch an operational state of a touch-sensitive display unit to an active state, wherein in the active state detection of a touch on the touch-sensitive display unit is enabled.

13. The non-transitory computer-readable medium as claimed in claim 12, wherein the control engine is to identify the physical configuration of the mobile computing device.

14. The non-transitory computer-readable medium as claimed in claim 12, wherein, based on the physical configuration, the control engine causes a controller of the touch-sensitive display unit to switch the operational state.
